(19) United States
(12) Patent Application Publication
(10) Pub. No.: US 2017/0096342 A1
(43) Pub. Date: Apr. 6, 2017

(54) GRAPHENE FILM AND MANUFACTURING METHOD THEREOF

(71) Applicant: Chung Yuan Christian University, Taoyuan City (TW)

(72) Inventors: Wei Song Hung, Taoyuan City (TW); Chien Chieh Hu, Taoyuan City (TW); Kueir Rarn Lee, Taoyuan City (TW); Juin Yih Lai, Taoyuan City (TW)

(21) Appl. No.: 14/875,699

(22) Filed: Oct. 6, 2015

(51) Int. Cl. C01B 31/04

(52) U.S. Cl. CPC C01B 31/0446

(57) ABSTRACT

A graphene film and a manufacturing method thereof are disclosed. A polymer solution and graphene flakes (such as graphene powder) are mixed to form liquid graphene. The liquid graphene is disposed, in batches, into a stirring device to be stirred uniformly by the stirring device. The stirred liquid graphene is coated on a substrate (such as a paper material) to form a graphene coating layer supported on the substrate. A drying device is used to remove liquid from the polymer solution. As such, the graphene flakes having a weak bonding force is first process to form liquid graphene, which is uniformly coated on a substrate to form a graphene film having a fixed shape and strong bonding force thereby integrally bonded to the substrate as a unitary structure. The graphene film has a structure in which the graphene flakes are stacked in the same direction to form a laminate.

### (a) TECHNICAL FIELD OF THE INVENTION

The present invention relates generally to a technique of bonding graphene, and more particularly to a graphene film and a manufacturing method thereof.

### (b) DESCRIPTION OF THE PRIOR ART

Graphene is extracted from graphite. Since graphene is of a planar structure having a hexagonal honeycomb lattice formed of carbon atoms of which the thickness corresponding to one single carbon atom, graphene shows various unique material properties in respect of electrical conductivity, heat dissipation capability, light transmittability, and excellent machinability, making it a nanometer material that is thinnest and hardest and has the smallest resistivity in the world.

However, before being properly processed and shaped, graphene is generally in the form of minute graphene flakes, such as graphene powder, showing a weak bonding power and thus in a loose form. This is a form that is not fit for commercial mass production and thus does not suit for direct applications in any field.

Referring to FIGS. 10, 11, 12, and 13, although media are available for bonding the graphene flakes as a bonded graphene object, the graphene flakes are distributed in a random and irregular manner in the structure of the bonded graphene object, and thus, the properties of electrical conduction, heat dissipation, and electromagnetic wave resistance thereof are affected.

Thus, it is an issue to be addressed in this field to have graphene bonded as a film with the material properties thereof improved for wide application in various fields.

In view of the above, the present invention aims to provide a solution for such an issue.

### SUMMARY OF THE INVENTION

An object of the present invention is to provide a manufacturing method that allows for making of a graphene film having excellent material properties.

To achieve the above object, the present invention provides a manufacturing method of a graphene film, which comprises: (a) mixing a polymer solution with graphene flakes to form liquid graphene; (b) placing the liquid graphene, in batches, in a stirring device to allow the liquid graphene to be stirred by the stirring device; (c) coating the stirred liquid graphene on a substrate to form a graphene coating layer so that the graphene coating layer is supported on and carried by the substrate; and (d) using a drying device to remove liquid from the polymer solution so as to form a graphene film having a fixed shape.

Another object of the present invention is to provide a graphene film having excellent material properties.

To achieve the object, a graphene film is manufactured with the graphene film manufacturing method according to the present invention, having an interior structure that comprises graphene flakes stacked in the same direction to form a laminate.

As such, the present invention allows loose graphene flakes having a weak bonding force to be processed to form liquid graphene, which is uniformly coated on a substrate to form a graphene film having a fixed shape and strong bonding force thereby integrally bonded to the substrate as a unitary structure. The graphene film so manufactured has a structure in which the graphene flakes are stacked in the same direction to form a laminate, which has excellent properties in respect of electrical conductivity, heat dissipation, and electromagnetic waver resistance and is applicable to various fields.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart of the present invention.

FIG. 2 is a cross-sectional view showing a structure of the present invention.

FIG. 3 is a cross-sectional view showing another structure of the present invention.

FIG. 4 is a graph of the present invention obtained through scanning with a scanning electron microscope (SEM).

FIG. 5 is another graph of the present invention obtained through scanning with a SEM.

FIG. 6 shows a cross section of the present invention obtained with a transmission electron microscope (TEM).

FIG. 7 is a plot of the result of a heat dissipation test of the present invention.

FIG. 8 is a plot of the result of an electromagnetic wave test of the present invention.

FIG. 9 is a plot of the result of another electromagnetic wave test of the present invention.

FIG. 10 is a cross-sectional view of a conventional bonded object of graphene.

FIG. 11 is a graph of the conventional bonded object of graphene obtained through scanning with a SEM.

FIG. 12 is another graph of the conventional bonded object of graphene obtained through scanning with a SEM.

FIG. 13 shows a cross section of the conventional bonded object of graphene obtained with a TEM.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

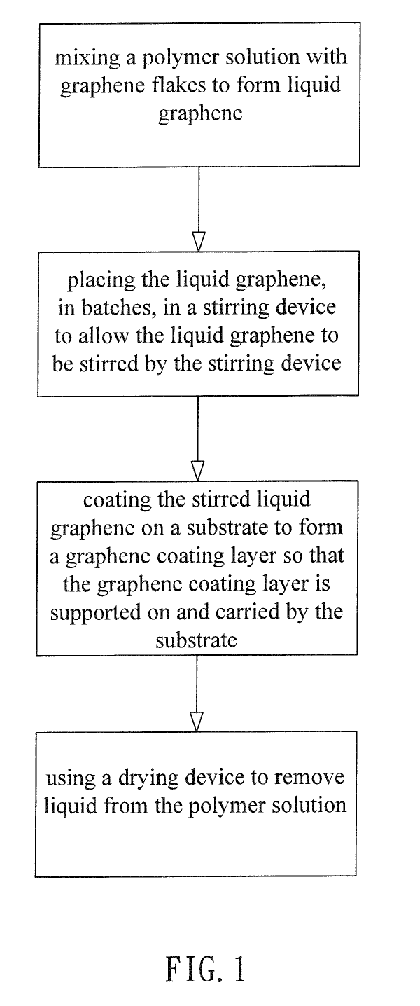

Referring to FIG. 1, the present invention provides a graphene film manufacturing method, which comprises the following steps:

(a) mixing a polymer solution with graphene flakes to form liquid graphene;

(b) placing the liquid graphene, in batches, in a stirring device to allow the liquid graphene to be stirred by the stirring device so as to have the graphene flakes and the polymer molecules uniformly distributed in the liquid graphene;

(c) coating the stirred liquid graphene on a substrate to form a graphene coating layer so that the graphene coating layer is supported on and carried by the substrate; and

(d) using a drying device to remove liquid from the polymer solution so as to have the polymer molecules bonded to the graphene flakes to form a graphene film having a fixed shape.

In one embodiment, the weight ratio of the polymer solution and the graphene flakes in the mixture is 1:0.5-1:5.

In one embodiment, the graphene flakes are in the form of graphene powder.

In one embodiment, the substrate is of a solid material, which is selected from flexible and non-flexible materials.

In one embodiment, the drying device comprises one of an ultraviolet irradiation device, an infrared irradiation device, or a high-temperature air stream generation device.

In one embodiment, the liquid graphene is deposited into the stirring device in a batched manner, wherein a basic reference quantity is divided into 5-15 batches sequentially added into the stirring device.

In one embodiment, the stirring device comprises a homogenizer.

As such, the present invention allows loose graphene flakes that have weak bonding forces therebetween to be first processed to form liquid graphene, which can be uniformly coated on a substrate, and then uses a drying device to remove the liquid part of the polymer solution to have polymer molecules to be bonded to the graphene flakes thereby forming a graphene film in the form of a fixed shape having a strong bonding force and integrally bonded to the substrate as a unitary structure.

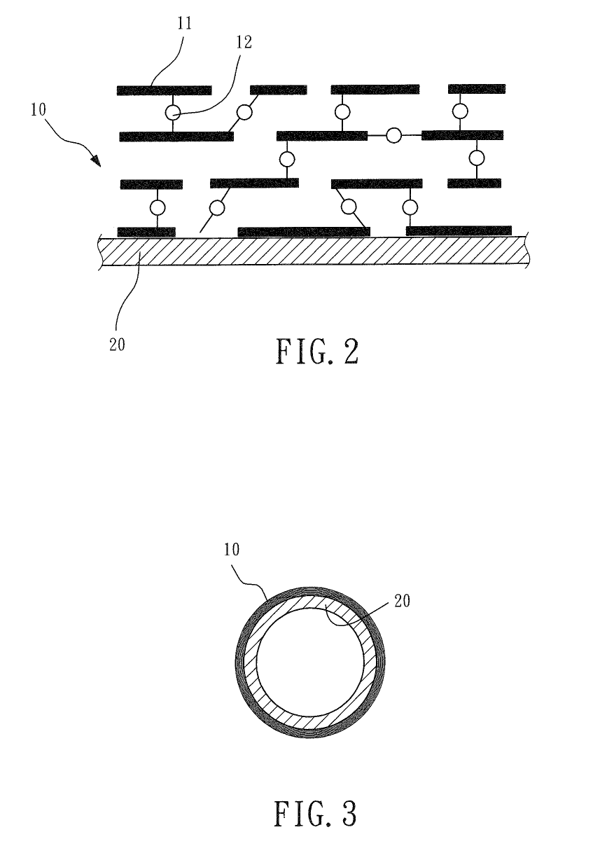

Referring to FIG. 2, a graphene film 10 made with the graphene film manufacturing method according to the present invention is bonded, with a strong bonding force, to a substrate 20 in an integrated and unitary form. An interior structure of the graphene film 10 is such that graphene flakes 11 are arranged as a laminate in the same, given direction with the polymer molecules 12 bonded to the graphene flakes.

Referring to FIG. 3, in one embodiment, the graphene film 10 may be formed to show a circular cross section.

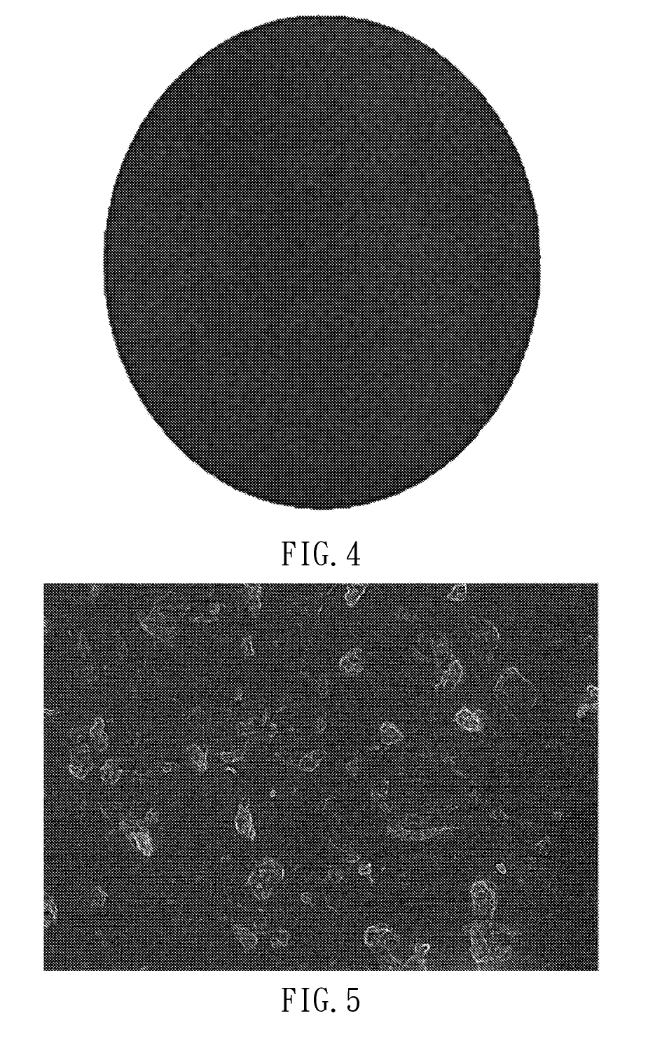

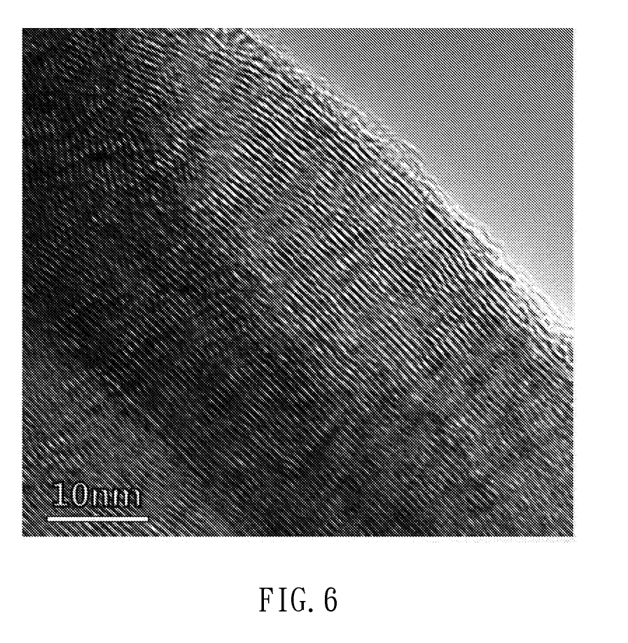

Referring to FIGS. 4 and 5, graphs of the graphene film of the present invention obtained through scanning with a scanning electron microscope (SEM) are illustrated, which demonstrate the graphene flakes are uniformly distributed. Referring to FIG. 6, a cross section of the graphene film of the present invention obtained with a transmission electron microscope (TEM) is illustrated, which demonstrates the graphene flakes form a regularly stacked laminate structure. As such, the graphene film according to the present invention shows excellent properties in respect of electrical conduction, heat dissipation, and electromagnetic wave resistance and is applicable to various fields.

Results of tests conducted on the present invention will be provided below to illustrate the excellent material properties of the graphene film according to the present invention.

(1) Electrical Conduction: Four-point probe tests are conducted on the graphene film of the present invention and a conventional graphene film.

The graphene film of the present invention has a regularly stacked laminate structure of the graphene flakes, while the graphene flakes of the conventional graphene film are arranged in an irregular random distribution. Test results show the graphene film of the present invention has a lower electrical resistance, namely having better electrical conductivity.

(2) Heat Dissipation: Heat dissipation tests have been conducted on the graphene film of the present invention by Aerospace Industrial Development Corp, Taiwan.

The test conditions are as follows: Test specimens include a graphene film of the present invention, a rolled copper foil, and a conventional graphene film, where acrylic is placed on the test specimen and a heater is arranged under the test specimen for heating. The temperatures of three locations of the acrylic are measured.

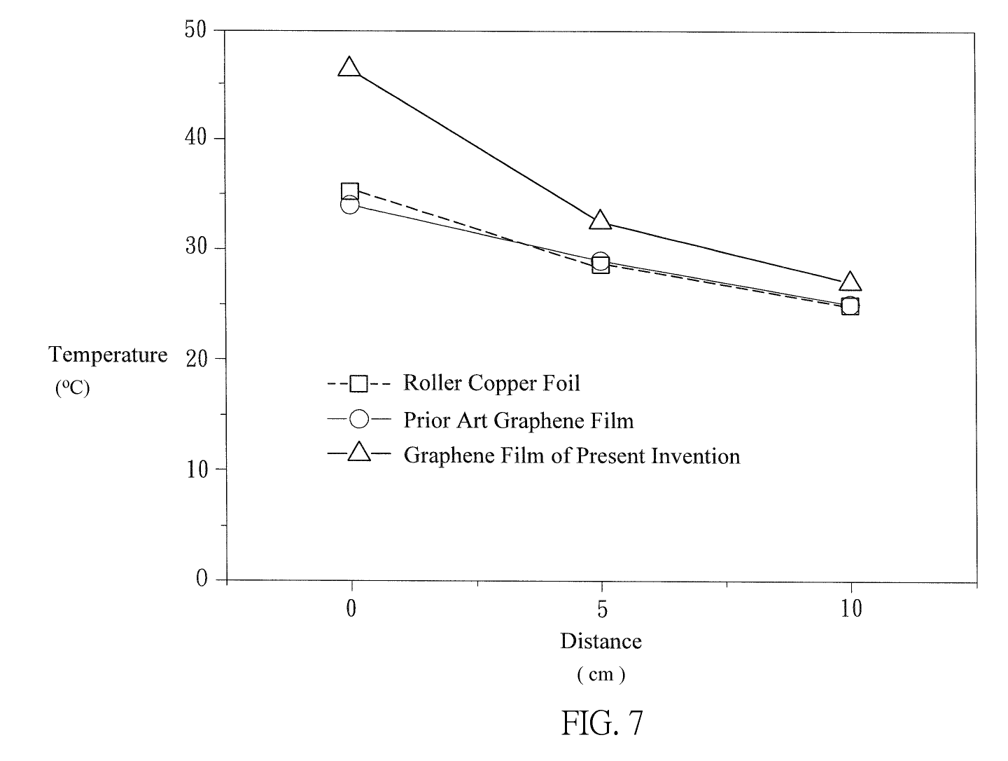

The results of the tests are as follows: Referring to the graphs of FIG. 7, the graphene film of the present invention has the highest temperatures at all the three locations of acrylic, meaning the property of heat dissipation is best.

(3) Electromagnetic wave resistance: Electromagnetic wave tests have been conducted on the graphene film of the present invention by Aerospace Industrial Development Corp, Taiwan.

Test Condition 1: a graphene film of the present invention and a conventional graphene film are held in a coaxial test jig to receive electromagnetic waves applied thereto, wherein a network analyzer is used to receive electromagnetic wave and analyze electromagnetic wave isolation performance, where isolation is achieved with the graphene film of the present invention and the conventional graphene film.

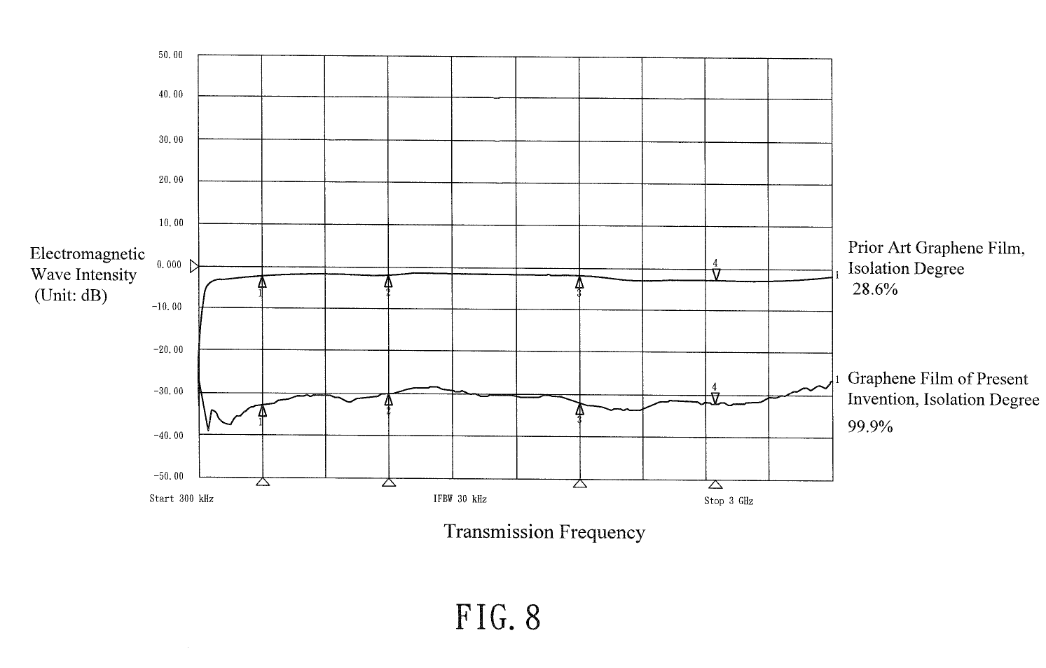

Test Result 1: Referring to FIG. 8, the intensity of electromagnetic wave is lower for isolation with the graphene film of the present invention, meaning excellent isolation can be achieved for the full band of electromagnetic wave.

Electromagnetic wave tests have been conducted on the graphene film of the present invention by National Taiwan University of Science and Technology.

Test Condition 2: A graphene film of the present invention is placed in a space that is free of electromagnetic waves and a test voltage is applied thereto. An electromagnetic wave receiver detects and receives the electromagnetic wave of the graphene film of the present invention.

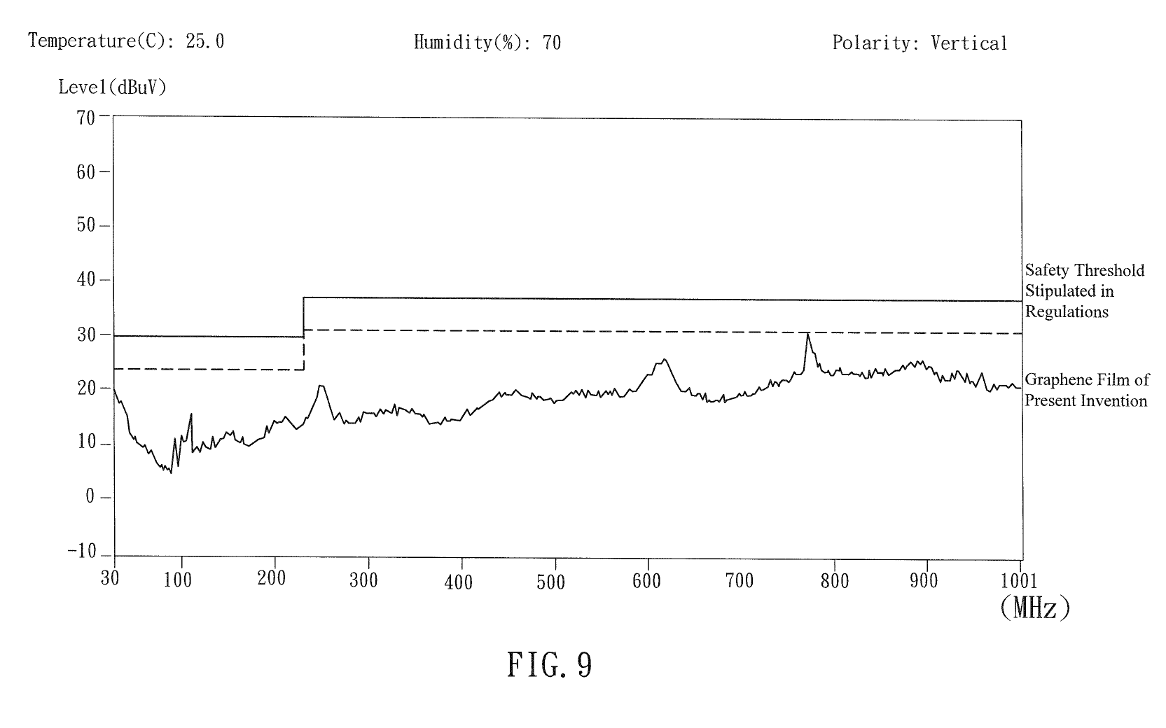

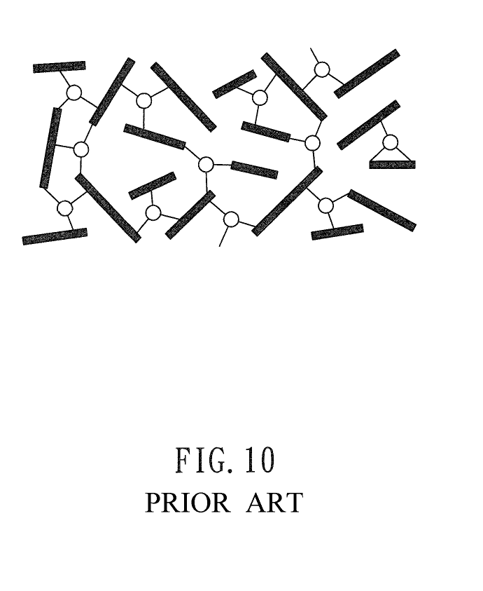

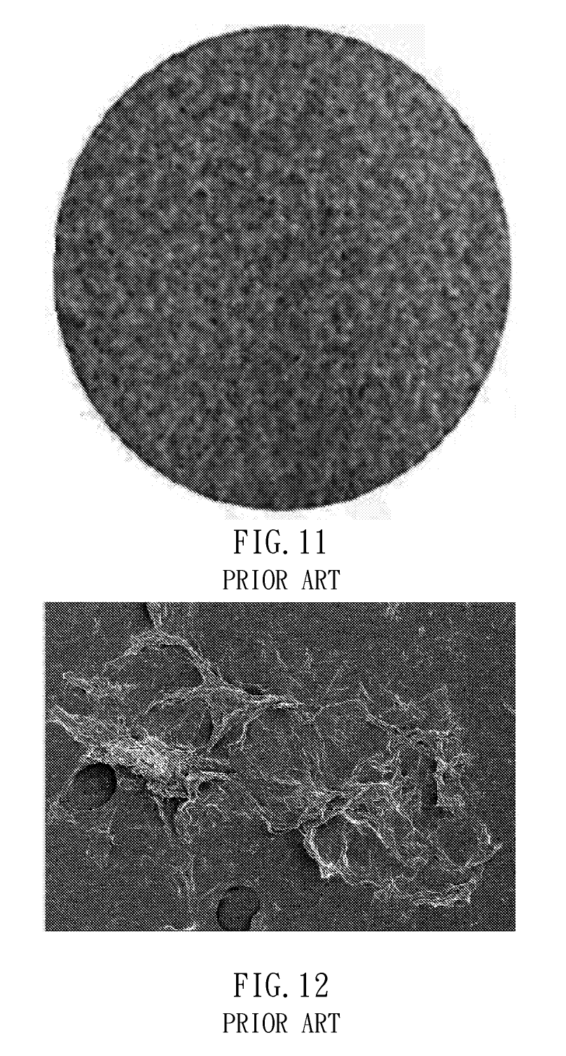

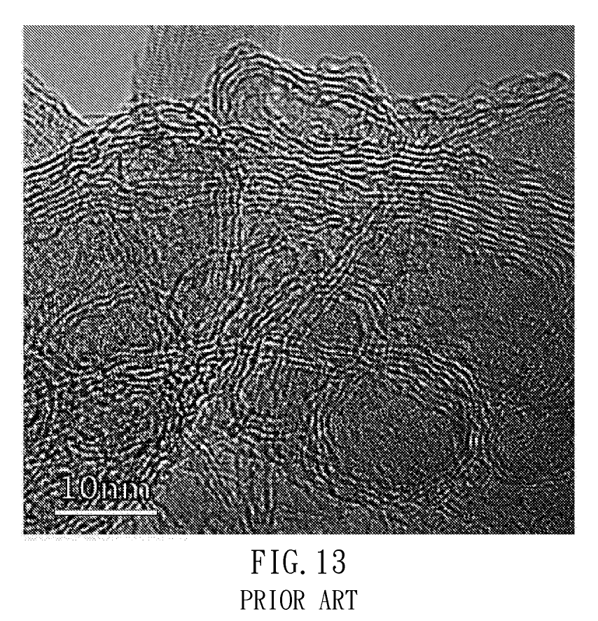

Test Result 2: Referring to FIG. 9, the intensity of electromagnetic wave detected and received by the electromagnetic wave receiver is far less than a safety threshold stipulated in related regulations, meaning the electromagnetic radiation is low.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A graphene film manufacturing method, comprising the following steps:
(a) mixing a polymer solution with graphene flakes to form liquid graphene;
(b) placing the liquid graphene, in batches, in a stirring device to allow the liquid graphene to be stirred by the stirring device;
(c) coating the stirred liquid graphene on a substrate to form a graphene coating layer so that the graphene coating layer is supported on and carried by the substrate; and
(d) using a drying device to remove liquid from the polymer solution so as to form a graphene film having a fixed shape.

2. The graphene film manufacturing method according to claim 1, wherein weight ratio of the polymer solution and the graphene flakes in the mixture is 1:0.5-1:5.

3. The graphene film manufacturing method according to claim 1, wherein the graphene flakes are in the form of graphene powder.

4. The graphene film manufacturing method according to claim 1, wherein the substrate is of a solid material.

5. The graphene film manufacturing method according to claim 1, wherein the drying device comprises one of an ultraviolet irradiation device, an infrared irradiation device, and a high-temperature air stream generation device.

6. The graphene film manufacturing method according to claim 1, wherein the liquid graphene is added in the stirring device in batches in such a way that a basic reference quantity is divided into 5-15 batches sequentially added into the stirring device.

7. The graphene film manufacturing method according to claim 1, wherein the stirring device comprises a homogenizer.

8. A graphene film manufactured with the method according to claim 1, having an interior structure that comprises the graphene flakes stacked in the same direction to form a laminate.

9. The graphene film according to claim 8 having a cross section that is circular.
